(19) United States
(12) Patent Application Publication
(10) Pub. No.: US 2006/0214783 A1
(43) Pub. Date: Sep. 28, 2006

(54) Smart Traffic Ticket Device

(76) Inventor: Nitesh Ratnakar, Oak Creek, WI (US)

Correspondence Address: NITESH RATNAKAR, 8600 S. LIBERTY LN #2410, OAK CREEK, WI, 53154, US

(21) Appl. No.: 10/907,271

(22) Filed: Mar. 27, 2005

(51) Int. Cl. G08B 26/00

(52) U.S. Cl. 340/505

(57) ABSTRACT

The present invention relates to a ‘smart traffic ticket device’ with means to 1) determine the identity of a vehicle; 2) determine the identity of the offending driver; 3) issue traffic tickets according to applicable traffic laws. The smart traffic ticket device comprises of; 1 ) an interrogator in the form of a radiofrequency (RF) reader; 2) communication means comprising of a wireless transceiver, modem and communication ports; and 3) a central processing unit comprising of a processor and memory chip that controls the functioning of the smart traffic ticket device. Transponders, comprising of radiofrequency (RF) tags, are mounted on vehicles; and contain vehicle identification information. Similarly, transponders, comprising of radiofrequency (RF) tags, are present on the driver's license; and contain driver identification information. The RF reader of the smart traffic ticket device has means to interrogate the RF tag on vehicles and the RF tag on the driver's license from a safe distance; both while the said vehicle is at rest and while the said vehicle is in motion. The information thus obtained is used to issue a traffic ticket bearing; 1 ) vehicle identification information; 2) driver identification information and; 3) nature of violation and; 4) the associated fine. According to another aspect of the present invention, the smart traffic ticket device is equipped with a traffic violation sensing device, such as a speed sensor, to form a ‘smart speeding ticket device’ . The smart speeding ticket device has means to 1) identify a vehicle driving over allowed speed limit; 2) determine the identity of the said speeding vehicle; 3) determine the identity of the driver of the said speeding vehicle; and 3) issue a speeding ticket to the said speeding vehicle according the applicable traffic laws.

### FIELD OF THE INVENTION

The present invention relates to a traffic ticket device; more specifically to a traffic ticket device that has means to 1) determine the identity of a vehicle; 2) determine the identity of the driver of a vehicle; and 3) to issue traffic tickets according to applicable traffic laws. According to another aspect, the present invention relates to a traffic ticket device that has means to automatically detect if a vehicle is in violation of any traffic law.

### BACKGROUND AND PRIOR ART

Identification of a vehicle and of its driver is important in the practice of issuing tickets for traffic violation. In the present system, a police officer has to identify a vehicle violating traffic rule either manually or by use of an electronic device such as a speed sensor. The police officer then follows the said vehicle and instructs the driver to pull over. The police officer then has to alight from his/her patrol car to manually inspect the vehicle to determine its identity and to manually inspect the driver's license of the offending driver to determine his/her identity. He/she then issues a traffic ticket bearing the identity of the vehicle, identity of the driver, nature of traffic violation and the associated fine. The present system of issuing tickets for traffic violations has many shortcomings. The disadvantages of the present system are 1) is a time consuming and labor intensive process; 2) even more concerning is the fact that it endangers the life of the police officer because a) the police officer has to alight from his vehicle and walk up to the offending vehicle, which is risky, especially on highways; b) sometimes the offending driver engages in a violent encounter with the police officer; 3) majority of drivers who violate traffic laws go undetected as the number of drivers who violate traffic laws far exceeds the monitoring capacity of law enforcement agencies. Fact of the matter is that highways and city streets are unmonitored for most part of the day. Consequently, large number traffic violations are never detected. The result is that in spite of the best efforts of law enforcement agencies, drivers still continue to violate traffic laws frequently. Every year, thousands of traffic accident related injuries and deaths are caused by drivers who do not follow traffic rules.

### OBJECTS OF THE INVENTION

Accordingly, there is a need for a traffic ticket device that has means to determine the identity of a vehicle and its driver from a safe distance without the need for a police officer to alight from his vehicle. Another object of the present invention is to design a traffic ticket device that has means to automate the process of issuing traffic tickets. Another object of the invention is to design a traffic ticket device that has means to automatically detect a traffic violation, such as speeding, and to automatically issue a ticket for the said violation.

### SUMMARY OF THE INVENTION

Accordingly, the present invention presents a ‘smart traffic ticket device’ to address the shortcomings of the present system of issuing traffic tickets, as discussed above. The present invention utilizes radiofrequency identification (RFID) technology. Radiofrequency tags (RF tag) are provided; that is mounted on the license plate of vehicles and contains vehicle identification information; including vehicle registration number, license plate number, make, model, year, color of the vehicle, owner identification information and any other information relating to vehicle identity. Similarly, radiofrequency tags (RF tags) are provided that is present in the driver's license; and contains driver's identification information. The ‘smart traffic ticket device’ comprises of a RF reader, a central processing unit and a communication means. Additionally, the ‘smart traffic ticket device’ may have sensing devices to enable it to automatically detect traffic violations; such as a speed sensor to enable it to detect vehicles driving over the allowed speed limit. Once a traffic violation is detected, either manually by a police officer or by the ‘smart traffic ticket device’; the RF reader of the ‘smart traffic ticket device’ is activated to remotely interrogate the RF tag on the offending vehicle and the RF tag on the driver's license. Information thus obtained is used to issue a traffic ticket bearing offending vehicle's identity, offending driver's identity nature of traffic violation and the associated fine. The said traffic ticket information is electronically transmitted to the RF tag on the offending vehicle, where it is stored. The RF tag on the vehicle is connected to an onboard display unit located in the vehicle; and information stored in the RF tag is displayed on the said display unit. Information regarding the said traffic ticket is also transmitted to a central control station for further processing.

### BRIEF DESCRIPTION OF THE DRAWINGS

FIG. 1A shows a radiofrequency tag (RF tag) mounted on the license plate of a vehicle.

FIG. 1B shows a radiofrequency tag (RF tag) present on a driver's license.

FIG. 2 illustrates the two-way communication between the RF tag and the RF reader; and it also illustrates the connection between the RF tag of the vehicle and an onboard display unit present in the vehicle.

FIG. 3A shows an outside view of the ‘smart traffic ticket device’.

FIG. 3B shows an inside view of the ‘smart traffic ticket device’.

FIG. 3C illustrates the two way connection between the central processing unit of the ‘smart traffic ticket device’ and its other components.

FIG. 4A shows an outside view of the ‘smart speeding ticket device’.

FIG. 4B shows an inside view of the ‘smart speeding ticket device’.

FIG. 4C illustrates the two way connection between the central processing unit of the ‘smart speeding ticket device’ and its other components.

FIG. 5 is an illustration of the algorithm used by the ‘smart speeding ticket device’ to identify a speeding vehicle; identify the vehicle and its driver; issue a speeding ticket to the said vehicle and; transmit the said speeding ticket information to a central control station.

FIG. 6 illustrates the communication network of the ‘smart speeding ticket device’.

FIG. 7A illustrates a method whereby; information obtained by the RF reader and the speed sensor of the ‘smart speeding ticket device’ is processed; and follow up action determined; at the ‘smart speeding ticket device’ level.

FIG. 7B illustrates a method whereby; information obtained by the RF reader and the speed sensor of the ‘smart speeding ticket device’ is transmitted to a central control station; where it is processed and follow up action determined.

### DETAILED DESCRIPTION OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out one or several purposes of the present invention. It is important, therefore, that the claims be regarded as including such equivalent constructions insofar as they do not depart from the spirit and scope of the present invention.

The smart traffic ticket device of the present invention utilizes radiofrequency identification (RFID) technology. RFID technology is a radio communication system that communicates between a radio transceiver, called an ‘Interrogator’ or ‘Reader’, and a number of inexpensive devices denoted as ‘Tags’ or ‘Transponders’. RF tags provide a means of obtaining data without direct contact such as is needed with magnetic strip or bar code technology. Such tags have been around for some time. U.S. Pat. No. 3,713,148 issued to Cardullo et al. on Jan. 23, 1973, and incorporated herein by reference, describes a tag, which includes a changeable or writable memory. The tags are self-contained in hermetically sealed capsules or laminates requiring no external power since they get power by rectifying the energy in a field created by the interrogator and storing the energy in capacitive-type circuitry. Nevertheless, some tags may be powered with small batteries. RF tags come in a variety of embodiments from a thin, flat and flexible form-factor (thin type) to small capsules (cylindrical type). An example of a thin form-factor is described in U.S. Pat. No. 5,528,222 issued to Moskowitz et al in 1996. In RF system, the reader communicates with the tags using modulated radio signals, which activate any tag in range; or a specific tag within the range. After activating a tag, the reader may transmit information to it (this is called the downlink). The reader transmits a continuous-wave (CW) radio signal to the tag; the tag then modulates the CW signal using modulated backscattering (MBS) in which the tag is electrically switched by the modulating signal, from being an absorber of RF radiation to a reflector of RF radiation. This modulated backscatter allows communications from the tag back to the reader (called the uplink). The downlink transmission of messages can include information relating to a desired operation of the RF tag and, for example, the reader is capable of instructing the RF tag to turn on and/or off on demand.

RF tags come in two varieties: active and passive. An active RF tag includes a battery or other power source, and is activated by a signal from a reading device. The activated RF tag then broadcasts its identification or other data, which is picked up by a reader. An advantage of active RF tags over passive RF tags is that the inclusion of a power source allows the active RF tag to transmit to a reader without entering into an electromagnetic field to power the tag circuit. Active RF tags are also generally able to transmit over a longer distance. The advantages of active RF tags have led to its use in automatic toll-paying systems, or the like. However, an active RF tag has certain disadvantages compared to a passive RF tag. For example, because the active RF tag requires a battery or other power source, it is more expensive and heavier than a passive RF tag. Additionally, the active RF tag becomes useless when the battery or other power source is depleted. Passive RF tags have no power supply per se, but power is provided to the RF circuitry by using an electromagnetic power receiver. The RF reading device sends power to the RF tag's electromagnetic power receiver, thus powering up or turning on the RF tag's circuits. Next, the passive RF tag broadcasts a response signal containing identification or other information, which is then read by the reading device. Because the passive RF tag has no battery, it is less expensive and lighter. Passive RF tags have been in use for some time, notably in security access cards where the user holds the card near the card reader to unlock a door, and in clothing stores as security tags attached to clothing items. Either technologies can be used with the ‘traffic ticket device’ of the present invention; depending of the desired features; and should not be considered limiting.

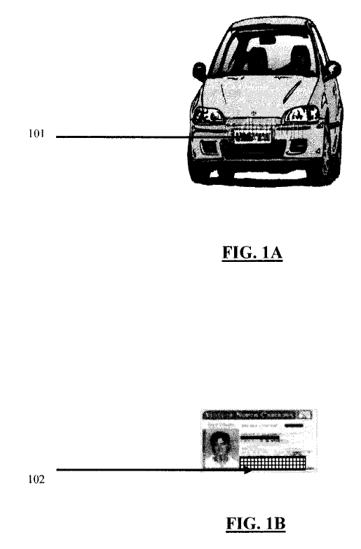

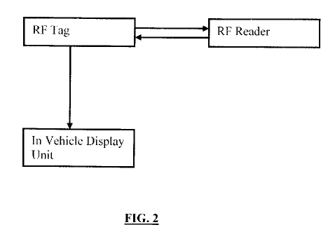

Transponder is provided in vehicles, which in the preferred embodiment is a radiofrequency tag (RF tag; 101). It is mounted on the license plate of as shown in FIG. 1A; but it can be present anywhere in the vehicle. In the preferred embodiment, the RF tag (101) is a passive tag but it could also be an active RF tag connected to a power source such as car battery. The RF tag (101) stores vehicle identification information like registration number, license plate number, vehicle identification number (VIN), year, make, model, color, owners name and contact information and the like. The information contained in the RF tag (101) can be updated whenever necessary, for example when there is change of ownership. Alternately, vehicle identification information, including registration number, license plate number, VIN, make, model and year of the vehicle and the like is stored in a central computer system, which maintains a database containing information pertaining to all vehicles. Individual vehicle identification data is linked to a unique serial number stored in the RF tag (101) of the corresponding vehicle. The said database is organized such that reference is made to vehicles by their respective RF tag serial numbers; and data linked to a corresponding RF tag serial number can be readily pulled. Either of these two methods can be used with the present invention and should not be considered limiting. As shown in FIG. 2, the RF tag (101) is connected to an onboard display unit in the vehicle which enables display of information contained in the RF tag (101) for the benefit of drivers. FIG. 2 also illustrates that the RF tag (101) has means to store data received from the RF reader (301) of the smart traffic ticket device (300).

Similarly, transponder is provided in driver's license; which in the preferred embodiment is a radiofrequency tag (RF tag; 102) as shown in FIG. 1B. In the preferred embodiment, the RF tag (102) is a passive tag but it could also be an active RF tag. The RF tag (102) stores driver identification information like driver's name, date of birth, age, ethnicity, color of eyes, hair color, height, weight, address, phone number and any other pertinent information. The information contained in the RF tag (102) can be updated whenever necessary. Alternately, driver identification information is stored in a central computer system, which maintains a database containing information pertaining to all licensed drivers. Individual driver identification information is linked to a unique serial number stored in the RF tag (102) of the corresponding driver's license. The said database is organized such that reference is made to drivers by the RF tag serial number on their respective driver's license; and data linked to a corresponding RF tag serial number can be readily pulled. Either of these two methods can be used with the present invention and should not be considered limiting.

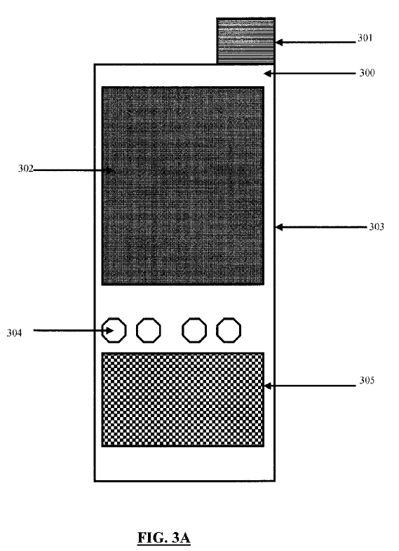

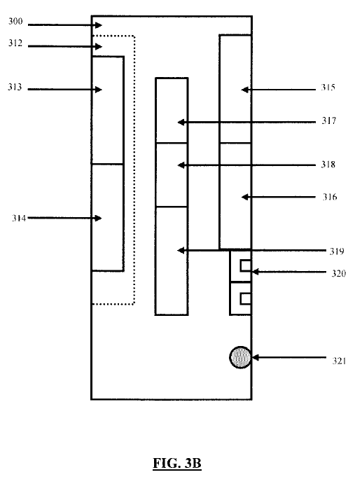

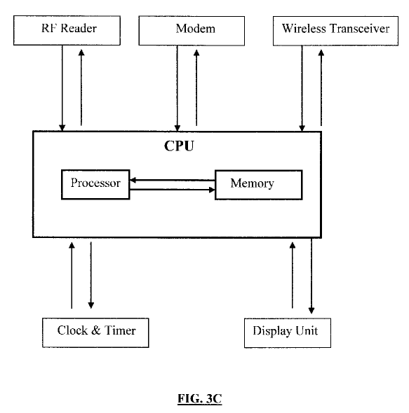

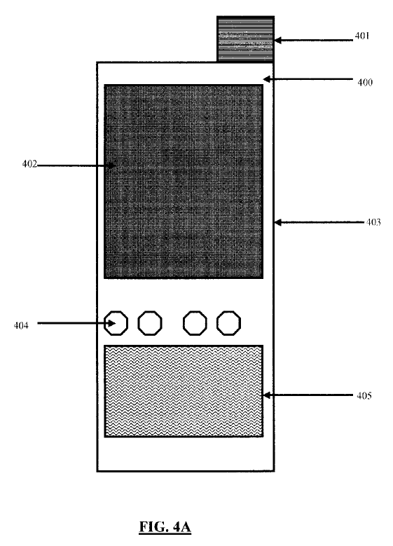

The ‘smart traffic ticket device’ of the present invention is shown in FIGS. 3A, 3B & 3C. It is a portable device that is designed to be carried by police officers on patrol. The smart traffic ticket device (300) comprises of an interrogator in the form of RF reader (301). The interrogation range of the RF reader (301) is enough to enable the police officer to interrogate the RF tag (101) of a vehicle and the RF tag of the driver's license (102) from a safe distance and obtain vehicle and driver identification information. In addition to the interrogator, the smart traffic ticket device (300) contains a central processing unit (CPU; 312) comprising of a processor (313) and a memory chip (314). The CPU (312) is programmed with traffic laws and fine schedule for various traffic violations. A modem (315), two-way wireless transceiver (316) and communication ports (320) are provided in the smart traffic ticket device (300); which serve as communication means. An internal clock (317) and timer (318); with means to control and trigger time sensitive functions; are provided in the smart traffic ticket device (300). The smart traffic ticket device (300) is enclosed in a housing (303), which preferably, is made of a tamper proof, weather and water resistant material. A display unit (302), which in the preferred embodiment is a liquid crystal display (LCD) screen, is provided on the housing. A plurality of control switches (304) is provided that enables local command entry into the smart traffic ticket device (300). Commands can also be entered into the smart traffic ticket device (300) via the display unit (302) using touch screen technology or using a keyboard (305). The CPU (312) can also be programmed remotely using the modem (315) and/or wireless transceiver (316). A battery compartment (319) is located in the housing, which holds one or more batteries to power the smart traffic ticket device (300). An electrical terminal (321) for connection to an external source of power is also provided. As illustrated in FIG. 3C, the CPU has two way communication with other components of the smart traffic ticket device including RF reader, modem, wireless transceiver, clock, timer and display unit.

The CPU (312) of the smart traffic ticket device is programmed with detailed information regarding traffic laws and the associated fine structure for various traffic violations. The RF reader (301) of the smart traffic ticket device (300) has means to interrogate both the RF tag on the vehicle (101) and the RF tag (102) on the driver's license from a distance; which enables a police officer to obtain vehicle and driver identification information from a safe distance; without the need to alight from his/her patrol car. After pulling over a vehicle for traffic violation, the police officer uses the smart traffic ticket device (300) to interrogate the RF tag (101) of the vehicle and the RF tag (102) of the driver's license; and obtains the vehicle identification and the driver's identification contained therein respectively. The police officer enters the traffic violation information into the smart traffic ticket device (300) using control switches (304), external keyboard (305) or the display unit (302) using touch screen technology. The smart traffic ticket device (300) then issues a traffic ticket electronically which contains 1) driver information; 2) vehicle identification information; 3) nature of traffic violation and; 4) the associated fine. This electronic traffic ticket is similar to the conventional traffic tickets currently used. The traffic ticket information is transmitted to the RF tag (101) of the offending vehicle where it is stored and subsequently displayed on the display unit present in the offending vehicle. The traffic ticket is also transmitted to the central control station for further processing, which may include mailing the paper version of the electronic traffic ticket to the address linked to the RF tag (101) of the offending vehicle or to the address linked to the RF tag (102) of the offending driver's license.

Although in the preferred embodiment, the transponder is a radiofrequency transponder; other transponders like Surface Acoustic Wave (SAW) transponder or a Dense Wave Multiple Access (DWMA) transponder may be used, and should not be considered limiting. Similarly, although the term “radio frequency” is used, other parts of the electromagnetic spectrum may be used to create the energy field, and should not be considered limiting. UHF, microwave and millimeter wave sources may be used by the reader; depending on the distance between the reader and the tag; and the material to be penetrated.

The traffic ticket device of the present invention can also be modified to automatically detect traffic violations such as speeding; and to automatically issue a traffic violation ticket such as a speeding ticket. With the current system, a police officer identifies a speeding vehicle using a speed sensing device such as radar gun, laser gun and the like; subsequent to which the police officer follows the offending vehicle and instructs the driver to come to a complete halt. The police officer then determines the identity of the vehicle by manual inspection of the vehicle's license plate; determines the identity of the driver by manual inspection of the driver's license; and subsequently issues a speeding ticket. The said speeding ticket contains 1) offending vehicle identification information; 2) offending driver identification information; 3) nature of speeding violation and; 4) associated fine. This system has the following shortcomings; 1) it is tedious, labor intensive and time consuming as police officers have to manually look out for speeding vehicles; 2) at any given time a police officer can issue only one ticket, during which time, other drivers exceeding allowed speed limit to go undetected; 3) only a limited number of tickets can be issued during a specified time period; 4) allows speeding drivers to slow down when they see a police officer; 5) is operator dependent which sometimes results in police officers not issuing speeding ticket to drivers who have exceeded the allowed speed limit; 6) after pulling over an offending vehicle, the police officer has to alight from his/her patrol car to determine the identity of the vehicle and its driver and to issue a speeding ticket. This is unsafe, especially on highways, where sometimes police officers are hit by another vehicle while outside of their patrol cars; 7) sometimes offending drivers engage in a violent encounter with police officer; 8) sometimes offending driver do not stop when instructed by police officers which often leads to high speed police car chase.

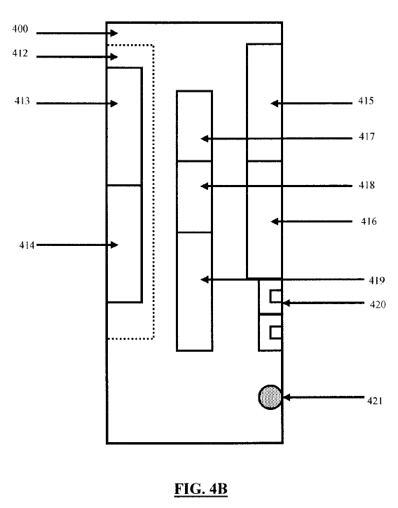

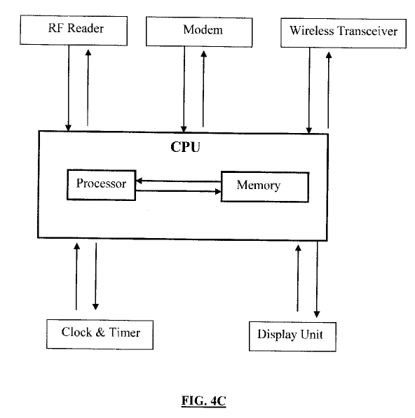

Accordingly there is a need for a device that can address the above mentioned shortcomings. We present a ‘smart speeding ticket device’ which is shown in FIGS. 4A, 4B & 4C. The smart speeding ticket device (400) has a speed sensor (405), such as a radar gun, laser gun and the like. The smart speeding ticket device (400) has an interrogator in the form of a RF reader (401). The RF reader (401) has an interrogation range such that it covers a pre determined area of a highway or city street (interrogation zone). In addition to the interrogator, the smart speeding ticket device (400) contains a central processing unit (CPU, 412) comprising of a processor (413) and a memory chip (414). The CPU (412) is programmed with speeding laws and fine schedule for speeding violations. A modem (415), two-way wireless transceiver (416) and communication ports (420) are provided in the smart speeding ticket device (400); which serve as communication means. An internal clock (417) and timer (418); with means to control and trigger time sensitive functions; are also provided. The smart speeding ticket device (400) is enclosed in a housing (403), which preferably, is made of a tamper proof, weather and water resistant material. A display unit (402), which in the preferred embodiment is a liquid crystal display (LCD) screen, is provided. A plurality of control switches (404) is provided that enables local command entry into the smart speeding ticket device (400). Commands can also be entered into the smart speeding ticket device (400) via the display unit (402) using touch screen technology or via an external keyboard. The smart speeding ticket device (400) can also be programmed remotely using the modem and/or the wireless transceiver. A battery compartment (419) is located in the housing, which holds one or more batteries to power the vehicle identification device. An electrical terminal (421) for connection to an external source of power is also provided. As shown in FIG. 4C, the CPU has two way communication with other components of the smart speeding ticket device including RF reader, modem, wireless transceiver, clock, timer and display unit. The CPU (412) is programmed with the speeding laws and the associated speeding fine schedule.

RF tags (101) are provided in vehicles, which in the preferred embodiment is mounted on the license plate as shown in FIG. 1A. The RF tag (101) contains vehicle identification information like registration number, license plate number, vehicle identification number (VIN), year, make, model, name and contact information of the owner and the like. The RF tag (101) also has means to store information obtained from the RF reader (401) of the smart speeding ticket device (400). Similarly the driver's license has a RF tag (102) as shown in FIG. 1B, which in the preferred embodiment, is embedded in the drivers license. The RF tag (102) on the driver's license contains driver's identification information. The RF reader (401) of the smart speeding ticket device (400) has means to interrogate both the RF tag (101) on the vehicle and the RF tag (102) on the driver's license; while the vehicle is in motion, even at high speeds.

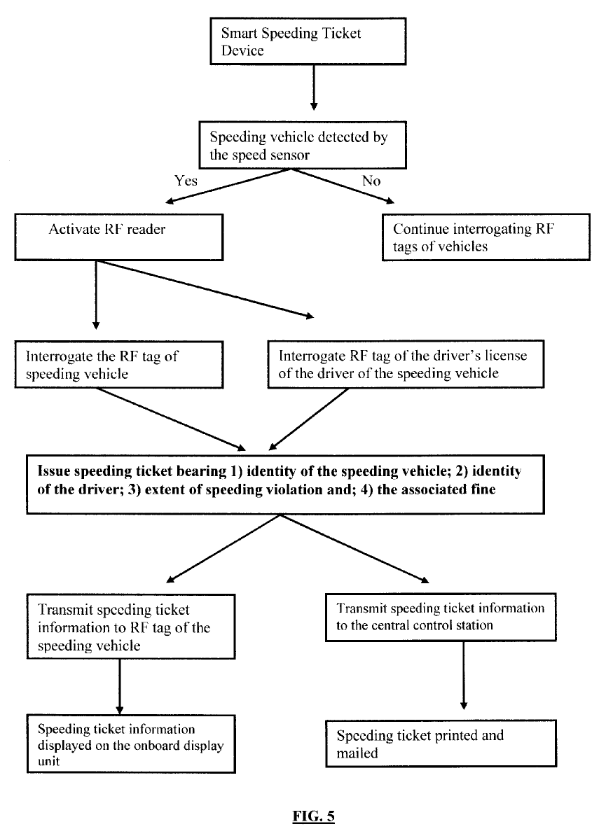

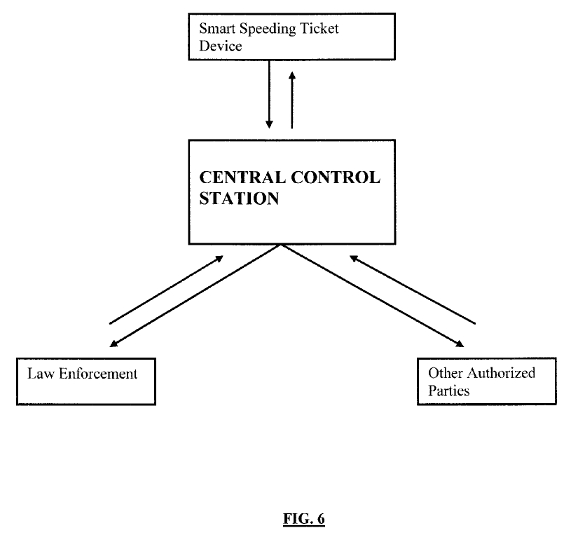

The working of the smart speeding device (400) is illustrated in FIG. 5. Smart speeding ticket devices (400) are placed along highways at locations where drivers are more likely to violate allowed speed limit. The RF reader (401) is activated when the speed sensor (405) detects a vehicle exceeding the allowed speed limit. The RF reader then interrogates the RF tag (101) of the offending vehicle and determines its identity. The RF reader also interrogates the RF tag (101 ) on the driver's license and obtains driver identification information. The smart speeding ticket device (400) then issues a speeding ticket in accordance with the speeding laws programmed into the CPU (412). The issued speeding ticket contains 1) vehicle identification information; 2) driver identification information and; 3) nature of speeding violation; 4) the associated fine. The smart speeding ticket device (400) transmits the speeding ticket information electronically to the RF tag (101) of the offending vehicle. By virtue of the connection of the RF tag (101) with an onboard display unit present in the offending vehicle, the speeding ticket information contained in the RF tag (101) of the offending vehicle is displayed on the onboard display unit of the offending vehicle for the benefit of the driver. Speeding ticket information is also transmitted to a central control station for further processing; which may include mailing the paper version o the electronic speeding ticket to the address linked to the RF tag (101) of the offending vehicle or to the address linked to the RF tag (102) of the offending driver's license. FIG. 6 illustrates that the smart speeding ticket device communicates with the central control station, which in turn communicates with other law enforcement personnel and other authorized parties. This is helpful not only in transmitting speeding ticket information to the central control station for further processing, but is also helpful in alerting law enforcement personnel about the identity of the said speeding vehicle; in case the said speeding vehicle is wanted for possible involvement in other crimes.

Although in the preferred embodiment, the transponder is a radiofrequency transponder; other transponders like Surface Acoustic Wave (SAW) transponder or a Dense Wave Multiple Access (DWMA) transponder may be used, and should not be considered limiting. Similarly, although the term “radio frequency” is used, other parts of the electromagnetic spectrum may be used to create the energy field, and should not be considered limiting. UHF, microwave and millimeter wave sources may be used by the reader; depending on the distance between the reader and the tag; and the material to be penetrated.

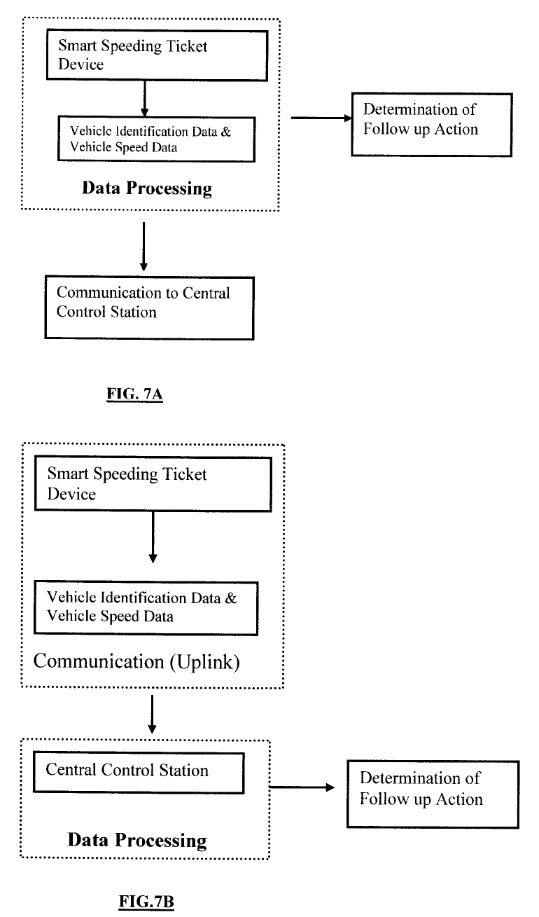

Determination of the speeding violation and of the identity of the offending vehicle can be made in two ways as shown in FIGS. 7A & 7B. The determination can be made at the smart speeding ticket device, whereby the CPU (412) is programmed to analyze the reading from the speed sensor (405) to determine if a vehicle is being driven over allowed speed limit. The CPU (412) is also programmed to analyze the data received from the RF reader (401) and determine the identity of an offending vehicle. According the second envisioned system, shown in FIG. 7B; the readings from the speed sensor (405) and the RF reader (401) is transmitted to the central control station, where determination regarding violation of allowed speed limit and identity of the offending vehicle is made. If a vehicle is determine to be in violation of the allowed speed limit, the central control station instructs the smart speeding ticket device (400) to issue an electronic speeding ticket. In addition, the central control station may also print out and mail a conventional speeding ticket.

The system of issuing speeding tickets proposed in the present invention has many advantages; 1) it issues speeding tickets to all speeding vehicles; unlike present system wherein only one ticket can be issued at any given time; 2) removes any bias and issues speeding ticket to all vehicles exceeding allowed speed limit, regardless of the extent of violation; 3) serves as a major deterrent to exceeding allowed speed limit because of #1 and #2; 4) is safer as it does not require manual presence of police officers to issue speeding tickets; 5) automates the process of issuing speeding tickets. Although in the preferred embodiment, we have presented a device to detect speeding violation; other types of sensors to detect other forms of traffic violation can also be used in the same way as the speed sensor in the smart speeding ticket device (400) of the preferred embodiment. This should not be considered limiting.

Our present invention will enable law enforcement officials to more efficiently and safely identify drivers who violate traffic laws and to issue them traffic tickets. We strongly believe our present invention will result in safer highways and city streets.

What is claimed is:

1. A vehicle identification device comprising of an interrogator with means to interrogate a transponder located in a vehicle.

2. The vehicle identification device of claim 1; wherein the interrogator is a radiofrequency reader.

3. The vehicle identification device of claim 1; wherein the interrogator has means to interrogate the transponder located in a vehicle from a distance.

4. A method to determine the identity of a vehicle comprising of:
a. The vehicle identification device of claim 1
b. A transponder; containing vehicle identification information; located in vehicles
c. The vehicle identification device interrogating the transponder of the said vehicle.

5. The transponder of claim 1, wherein it is a radiofrequency tag.

6. Driver's license containing a transponder.

7. The driver's license of claim 6; wherein the transponder is a radiofrequency tag.

8. The driver's license of claim 6; wherein the transponder contains identification information of the corresponding driver.

9. A method to determine the identify of a driver comprising of:
a. The vehicle identification device of claim 1
b. The driver's license of claim 6
c. The vehicle identification device interrogating the transponder of the driver's license.

10. A traffic violation detection device comprising of; a) A traffic violation sensor; b) An interrogator.

11. The traffic violation detection device of claim 10; wherein the traffic violation sensor has means to automatically detect a traffic violation.

12. The traffic violation detection device of claim 10; wherein the interrogator is a radiofrequency reader.

13. The traffic violation detection device of claim 10; wherein the interrogator has means to interrogate a transponder located in a vehicle.

14. The traffic violation detection device of claim 10; wherein the interrogator has means to interrogate a transponder located in a driver's license.

15. A method of issuing speeding tickets comprising of; a) The traffic violation detection device of claim 10; wherein the traffic violation sensor comprises of a speed sensor; b) A transponder; containing vehicle identification information; located in vehicles; c) The speed sensor of the traffic violation detection device determining the speed of vehicles passing through its interrogation zone; d) The interrogator of the traffic violation detection device interrogating the transponder of vehicles driving over allowed speed limit.

16. The method of issuing speeding ticket of claim 15; wherein the traffic violation detection device has means to issue speeding ticket to vehicles violating the allowed speed limit.

17. The method of issuing speeding ticket of claim 15; wherein the interrogator of the traffic violation detection device has means to interrogate the transponder located in a vehicle while the said vehicle is in motion.

18. The method of issuing speeding tickets of claim 15; wherein the traffic violation detection device has means to transmit speeding ticket information to the transponder of the offending vehicle.

19. The transponder of claim 15; wherein it is a radiofrequency tag.

20. The method of issuing speeding tickets of claim 15; wherein the traffic violation detection device has means to transmit speeding ticket information to a central control station.
